(19) United States
(12) Patent Application Publication
(10) Pub. No.: US 2022/0206669 A1
(43) Pub. Date: Jun. 30, 2022

(54) INFORMATION PROCESSING APPARATUS, INFORMATION PROCESSING METHOD, AND PROGRAM

(71) Applicant: SONY GROUP CORPORATION, Tokyo (JP)

(72) Inventor: Tetsuya KIKUKAWA, Tokyo (JP)

(73) Assignee: SONY GROUP CORPORATION, Tokyo (JP)

(21) Appl. No.: 17/612,073

(22) PCT Filed: Apr. 30, 2020
(86) PCT No.: PCT/JP2020/018230

§ 371 Date: Nov. 17, 2021

(30) Foreign Application Priority Data
Jul. 5, 2019 (JP) 2019-125718

(51) Int. Cl. G06F 3/04815; G06F 3/04886; G06F 3/04845

(52) U.S. Cl. CPC G06F 3/04815; G06F 2203/04803; G06F 3/04845; G06F 3/04886

(57) ABSTRACT

A display surface angle detection unit (40) (first detection unit) of a mobile terminal (10a) (information processing apparatus) detects the difference between normal directions of a display unit (first display area (S1), second display area (S2), and third display area (S3)) including display areas whose normal directions partially change, that is, an angle formed by adjacent display areas. Then, when an angle formed by adjacent display areas is equal to or greater than a predetermined value, a touch operation detection unit (41) (second detection unit) detects a touch operation on each of the display areas. A display control unit (42) (control unit) changes the display mode of the 3D model (14M) (object) displayed in the second display area (S2) (display unit) in accordance with a touch operation on each of the display areas (first display area (S1), second display area (S2), and third display area (S3)).

### FIELD

The present disclosure relates to an information processing apparatus, an information processing method, and a program, and more particularly, to an information processing apparatus, an information processing method, and a program capable of intuitively and freely moving a 3D object displayed on a screen.

### BACKGROUND

Recently, there has been developed a technique for displaying a 3D object in an image or a video of viewing space captured by a camera in a mobile terminal including the camera represented by a smartphone. In such a system, a 3D object is generated in viewing space by using information obtained by sensing real 3D space, for example, a multi-viewpoint video obtained by imaging a subject from different viewpoints, and displayed as if the object exists in the viewing space (also referred to as volumetric video) (e.g., Patent Literature 1).

### CITATION LIST

### Patent Literature

Patent Literature 1: JP H11-185058 A

### SUMMARY

### Technical Problem

A 3D object displayed in such a way can be desirably moved freely by an instruction of a user (observer or operator).

For example, however, in Patent Literature 1, an object is specified by using a pointer operated with a mouse, and a necessary movement operation is performed. It is thus difficult to move a 3D object intuitively and freely.

Furthermore, these days, an object in a screen can be easily specified by using an operation system using a touch panel. Then, the object can be two-dimensionally moved by a slide operation (swipe operation) or a flick operation after the object is specified. In the slide operation, a screen is traced with a finger. In the flick operation, the screen is flipped with the finger. In order to three-dimensionally move the object, however, it is necessary to separately designate a three-dimensional movement direction after the object is selected, so that it is difficult to move the object intuitively and freely.

Therefore, the present disclosure proposes an information processing apparatus, an information processing method, and a program capable of three-dimensionally and freely moving an object displayed on a display screen by intuitive interaction.

### Solution to Problem

To solve the problems described above, an information processing apparatus according to an embodiment of the present disclosure includes: a first detection unit that detects a normal direction of a display unit including a display area whose normal direction partially or continuously changes; a second detection unit that detects a touch operation on the display area; and a control unit that changes a display mode of an object displayed on the display area in accordance with at least one of the normal direction and a touch operation on the display area.

### BRIEF DESCRIPTION OF DRAWINGS

FIG. 1 illustrates one example of a mobile terminal including a foldable display unit according to a first embodiment.

FIG. 2 illustrates one example of a method of moving a 3D model displayed on the mobile terminal according to the first embodiment.

FIG. 3 is a hardware block diagram illustrating one example of the hardware configuration of the mobile terminal according to the first embodiment.

FIG. 4 is a functional block diagram illustrating one example of the functional configuration of the mobile terminal according to the first embodiment.

FIG. 5 is a flowchart illustrating one example of the flow of processing performed by the mobile terminal according to the first embodiment.

FIG. 6 outlines a mobile terminal according to a second embodiment.

FIG. 7 illustrates one example of a screen displayed on the mobile terminal according to the second embodiment.

FIG. 8 is a flowchart illustrating one example of the flow of processing performed by the mobile terminal according to the second embodiment.

FIG. 9 outlines a mobile terminal according to a third embodiment.

FIG. 10 is a flowchart illustrating one example of the flow of processing performed by the mobile terminal according to the third embodiment.

FIG. 11 outlines a variation of the third embodiment.

FIG. 12 outlines a mobile terminal according to a fourth embodiment.

FIG. 13 is a functional block diagram illustrating one example of the functional configuration of the mobile terminal according to the fourth embodiment.

FIG. 14 is a flowchart illustrating one example of the flow of processing performed by the mobile terminal according to the fourth embodiment.

FIG. 15 illustrates one example of an information processing apparatus according to a fifth embodiment.

FIG. 16 illustrates a method of detecting deflection of a display panel.

FIG. 17 is a hardware block diagram illustrating one example of the hardware configuration of the information processing apparatus according to the fifth embodiment.

FIG. 18 is a functional block diagram illustrating one example of the functional configuration of the information processing apparatus according to the fifth embodiment.

### DESCRIPTION OF EMBODIMENTS

Embodiments of the present disclosure will be described in detail below with reference to the drawings. Note that, in each of the following embodiments, the same reference signs are attached to the same parts to omit duplicate description.

Furthermore, the present disclosure will be described in accordance with the following item order.

### 1. First Embodiment

1-1. Outline of Mobile Terminal of First Embodiment

1-2. Hardware Configuration of Mobile Terminal

1-3. Functional Configuration of Mobile Terminal

1-4. Flow of Processing Performed by Mobile Terminal

1-5. Effects of First Embodiment

2. Second Embodiment

2-1. Outline of Mobile Terminal of Second Embodiment

2-2. Flow of Processing Performed by Mobile Terminal

2-3. Effects of Second Embodiment

3. Third Embodiment

3-1. Outline of Mobile Terminal of Third Embodiment

3-2. Flow of Processing Performed by Mobile Terminal

3-3. Effects of Third Embodiment

3-4. Variation of Third Embodiment

3-5. Effects of Variation of Third Embodiment

4. Fourth Embodiment

4-1. Outline of Mobile Terminal of Fourth Embodiment

4-2. Functional Configuration of Mobile Terminal

4-3. Flow of Processing Performed by Mobile Terminal

4-4. Effects of Fourth Embodiment

5. Fifth Embodiment

5-1. Outline of Information Processing Apparatus of Fifth Embodiment

5-2. Hardware Configuration of Information Processing Apparatus

5-3. Functional Configuration of Information Processing Apparatus

5-4. Effects of Fifth Embodiment

### 1. First Embodiment

A first embodiment of the present disclosure is an example of a mobile terminal (information processing apparatus) having a function of changing the display mode of a 3D model displayed on a foldable display area in accordance with a touch operation on the display area.

### 1-1. Outline of Mobile Terminal of First Embodiment

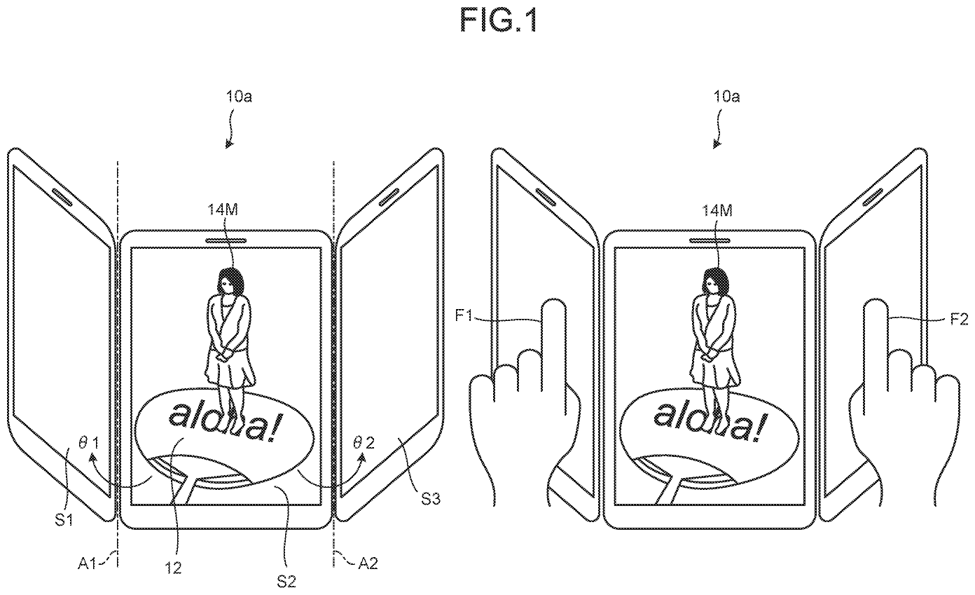

FIG. 1 illustrates one example of a mobile terminal including a foldable display unit according to a first embodiment. A mobile terminal 10a includes a first display area S1, a second display area S2, and a third display area S3, which are foldable. The first display area S1 and the second display area S2 can freely turn with a turning axis A1 as a supporting axis. Furthermore, the second display area S2 and the third display area S3 can freely turn with a turning axis A2 as a supporting axis. FIG. 1 illustrates the first display area S1 and the second display area S2, which are disposed to form an angle θ1 (θ1>180°). Furthermore, FIG. 1 illustrates the second display area S2 and the third display area S3, which are disposed to form an angle θ2 (θ2>180°). As described above, the first display area S1, the second display area S2, and the third display area S3 have normal directions that are different for each display area, that is, different partially. That is, the mobile terminal 10a includes a display unit having the display areas (first display area S1, second display area S2, and third display area S3) whose normal directions partially change. Note that the mobile terminal 10a is one example of an information processing apparatus in the present disclosure.

In the mobile terminal 10a, for example, a 3D model 14M is drawn in the second display area S2. When an augmented reality (AR) marker 12 is detected by an AR application that operates in the mobile terminal 10a at the time when the AR marker 12 is displayed in the second display area S2, the 3D model 14M is displayed at a position of the AR marker 12.

The 3D model 14M is a subject model generated by performing 3D modeling on a plurality of viewpoint images, which is obtained by volumetrically capturing a subject with a plurality of synchronized imaging apparatuses. That is, the 3D model 14M has three-dimensional information on the subject. The 3D model 14M includes mesh data, texture information, and depth information (distance information). The mesh data expresses geometry information on a subject in the connection of vertices, which is referred to as a polygon mesh. The texture information and the depth information correspond to each polygon mesh. Note that information that the 3D model 14M has is not limited thereto. The 3D model 14M may include other information.

When a user of the mobile terminal 10a performs a touch operation on the first display area S1 with his/her finger F1, the content of the touch operation is detected by the action of a touch panel laminated on the first display area S1. Then, the display mode of the 3D model 14M is changed in accordance with the content of the detected touch operation.

Furthermore, when the user of the mobile terminal 10a performs a touch operation on the third display area S3 with his/her finger F2, the content of the touch operation is detected by the action of a touch panel laminated on the third display area S3. Then, the display mode of the 3D model 14M is changed in accordance with the content of the detected touch operation.

Moreover, when the user of the mobile terminal 10a performs a touch operation on the second display area S2 with his/her finger F1 or F2, the content of the touch operation is detected by the action of a touch panel laminated on the second display area S2. Then, the display mode of the 3D model 14M is changed in accordance with the content of the detected touch operation. Note that, as illustrated in FIG. 1, a mode of appreciating the 3D model 14M from only one direction is referred to as a one-direction appreciation mode in the present disclosure for convenience.

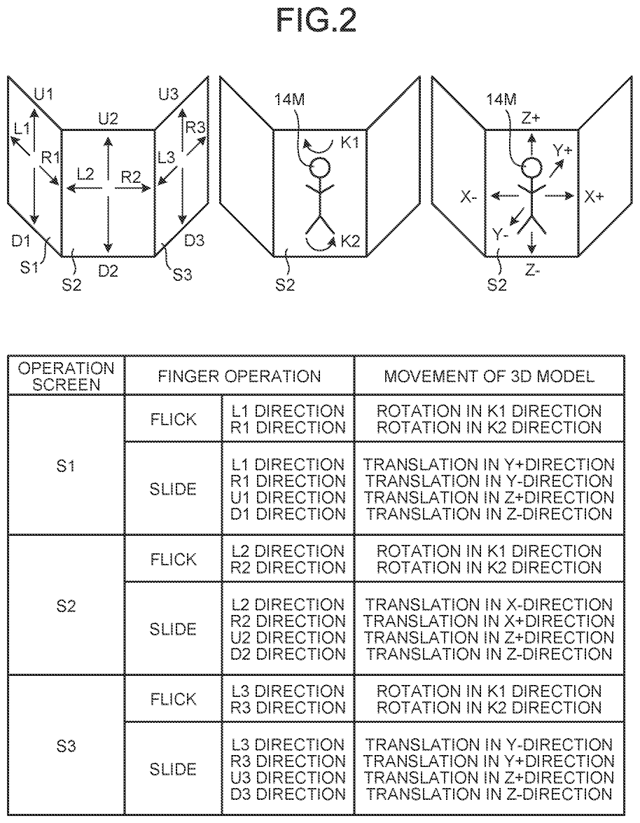

FIG. 2 illustrates one example of a method of moving a 3D model displayed on the mobile terminal according to the first embodiment.

First, a case where the display mode of the 3D model 14M displayed in the second display area S2 is changed by performing a touch operation on the first display area S1 disposed to form the angle θ1 (θ1>180°) together with the second display area S2 will be described. The display mode of the 3D model 14M is changed by performing a flick operation (operation of flipping finger touching screen in specific direction) or a slide operation (operation of moving finger touching screen as it is in specific direction, also referred to as swipe operation) on the first display area S1. Note that, in relation to directions in which a flick operation or a slide operation is performed on the first display area S1, as illustrated in FIG. 2, the direction toward the back side is defined as L1, the direction toward the front side is defined as R1, the direction toward the upside is defined as U1, and the direction toward the downside is defined as D1.

In the case, the 3D model 14M displayed on the second display area S2 is rotated in the direction of an arrow K1 by performing a flick operation in the L1 direction. Conversely, the 3D model 14M is rotated in the direction of an arrow K2 by performing a flick operation in the R1 direction. Note that the rotation amount for one flick operation is preliminarily set. For example, when the rotation amount for one flick operation is set to 20°, nine flick operations can invert the 3D model 14M (rotate 3D model 14M by 1800 in direction of arrow K1 or K2).

Moreover, the 3D model 14M displayed on the second display area S2 is translated in a Y+ direction by performing a slide operation in the L1 direction. That is, the 3D model 14M moves away as viewed from a user. Furthermore, the 3D model 14M is translated in a Y-direction by performing a slide operation in the R1 direction. That is, the 3D model 14M moves in a direction closer to the user. Furthermore, the 3D model 14M is translated in a Z+ direction by performing a slide operation in the U1 direction. That is, the 3D model 14M moves upward in the second display area S2. Furthermore, the 3D model 14M is translated in a Z− direction by performing a slide operation in the D1 direction. That is, the 3D model 14M moves downward in the second display area S2.

As described above, in the embodiment, the display mode of the 3D model 14M is changed by causing an operation performed on the first display area S1 to act on the 3D model 14M displayed in the second display area S2 from the direction in accordance with the normal direction of the first display area S1. This enables intuitive three-dimensional movement of the 3D model 14M.

Next, a case where the display mode of the 3D model 14M displayed in the second display area S2 is changed by performing a touch operation on the third display area S3 disposed to form the angle θ2 (θ2>180°) together with the second display area S2 will be described. The display mode of the 3D model 14M is changed by performing a flick operation or a slide operation on the third display area S3. Note that, in relation to directions in which a flick operation or a slide operation is performed on the third display area S3, as illustrated in FIG. 2, the direction toward the back side is defined as R3, the direction toward the front side is defined as L3, the direction toward the upside is defined as U3, and the direction toward the downside is defined as D3.

In the case, the 3D model 14M displayed on the second display area S2 is rotated in the direction of the arrow K2 by performing a flick operation in the R3 direction. Conversely, the 3D model 14M is rotated in the direction of the arrow K1 by performing a flick operation in the L3 direction.

Moreover, the 3D model 14M displayed on the second display area S2 is translated in the Y+ direction by performing a slide operation in the R3 direction. That is, the 3D model 14M moves away as viewed from the user. Furthermore, the 3D model 14M is translated in the Y− direction by performing a slide operation in the L3 direction. That is, the 3D model 14M moves in a direction closer to the user. Furthermore, the 3D model 14M is translated in the Z+ direction by performing a slide operation in the U3 direction. That is, the 3D model 14M moves upward in the second display area S2. Furthermore, the 3D model 14M is translated in the Z− direction by performing a slide operation in the D3 direction. That is, the 3D model 14M moves downward in the second display area S2.

As described above, in the embodiment, the display mode of the 3D model 14M is changed by causing an operation performed on the third display area S3 to act on the 3D model 14M displayed in the second display area S2 from the direction in accordance with the normal direction of the third display area S3. This enables intuitive three-dimensional movement of the 3D model 14M.

Next, a case where the display mode of the 3D model 14M displayed in the second display area S2 is changed by performing a touch operation on the second display area S2 will be described. The display mode of the 3D model 14M is changed by performing a flick operation or a slide operation on the second display area S2. Note that, in relation to directions in which a flick operation or a slide operation is performed on the second display area S2, as illustrated in FIG. 2, the direction toward the upside is defined as U2, the direction toward the downside is defined as D2, the direction toward the left side is defined as L2, and the direction toward the right side is defined as R2.

In the case, the 3D model 14M displayed on the second display area S2 is rotated in the direction of the arrow K2 by performing a flick operation in the R2 direction. Conversely, the 3D model 14M is rotated in the direction of the arrow K1 by performing a flick operation in the L2 direction.

Moreover, the 3D model 14M displayed on the second display area S2 is translated in an X− direction by performing a slide operation in the L2 direction. That is, the 3D model 14M moves to the left as viewed from the user. Furthermore, the 3D model 14M is translated in an X+ direction by performing a slide operation in the R2 direction. That is, the 3D model 14M moves to the right as viewed from the user. Furthermore, the 3D model 14M is translated in the Z+ direction by performing a slide operation in the U2 direction. That is, the 3D model 14M moves upward in the second display area S2. Furthermore, the 3D model 14M is translated in the Z− direction by performing a slide operation in the D2 direction. That is, the 3D model 14M moves downward in the second display area S2.

As described above, although it is difficult to move the 3D model 14M in the depth direction of the second display area S2 by an intuitive operation on the second display area S2, an operation instruction given from the first display area S1 or the third display area S3 enables the intuitive movement of the 3D model 14M in the depth direction.

### 1-2. Hardware Configuration of Mobile Terminal

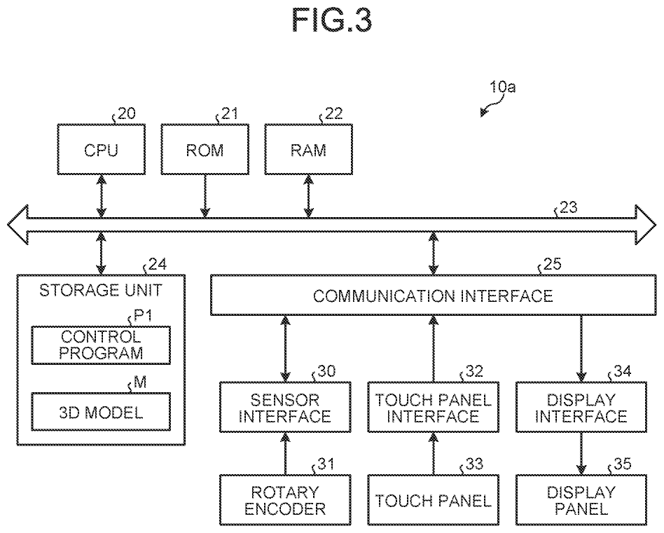

FIG. 3 is a hardware block diagram illustrating one example of the hardware configuration of the mobile terminal according to the first embodiment. In particular, FIG. 3 illustrates only elements related to the embodiment among hardware components of the mobile terminal 10a of the embodiment. That is, the mobile terminal 10a has a configuration in which a central processing unit (CPU) 20, a read only memory (ROM) 21, a random access memory (RAM) 22, a storage unit 24, and a communication interface 25 are connected by an internal bus 23.

The CPU 20 controls the entire operation of the mobile terminal 10a by developing and executing a control program P1 stored in the storage unit 24 or the ROM 21 on the RAM 22. That is, the mobile terminal 10a has a configuration of a common computer that is operated by the control program P1. Note that the control program P1 may be provided via a wired or wireless transmission medium such as a local area network, the Internet, and digital satellite broadcasting. Furthermore, the mobile terminal 10a may execute a series of pieces of processing with hardware.

The storage unit 24 includes, for example, a flash memory, and stores the control program P1 executed by the CPU 20 and information on the 3D model M and the like. The 3D model M includes 3D information on a preliminarily created subject. The 3D model M includes a plurality of 3D models 14M obtained by observing a subject from a plurality of directions. Note that, since the 3D model M commonly has a large capacity, the 3D model M may be downloaded from an external server (not illustrated) connected to the mobile terminal 10a via the Internet or the like, and stored in the storage unit 24 as necessary.

The communication interface 25 is connected to a rotary encoder 31 via a sensor interface 30. The rotary encoder 31 is installed on the turning axis A1 and the turning axis A2, and detects a rotation angle formed by display areas around the turning axis A1 or the turning axis A2. The rotary encoder 31 includes a disk and a fixed slit. The disk rotates together with a turning axis, and includes slits formed at a plurality of pitches in accordance with radial positions. The fixed slit is installed near the disk. The absolute value of the rotation angle is output by applying light on the disk and detecting transmitted light that has passed through a slit. Note that any sensor capable of detecting a rotation angle around an axis can be substituted in addition to the rotary encoder 31. For example, a variable resistor and a variable capacitor can be used. The resistance value of the variable resistor changes in accordance with the rotation angle around the axis. The capacitance value of the variable capacitor changes in accordance with the rotation angle around the axis.

Furthermore, the communication interface 25 acquires operation information on touch panels 33 laminated on the first to third display areas (S1, S2, and S3) of the mobile terminal 10a via a touch panel interface 32.

Moreover, the communication interface 25 displays image information on a display panel 35 constituting the first to third display areas (S1, S2, and S3) via a display interface 34. The display panel 35 includes, for example, an organic EL panel and a liquid crystal panel.

Furthermore, although not illustrated, the communication interface 25 communicates with an external server (not illustrated) or the like by wireless communication, and receives a new 3D model M and the like.

### 1-3. Functional Configuration of Mobile Terminal

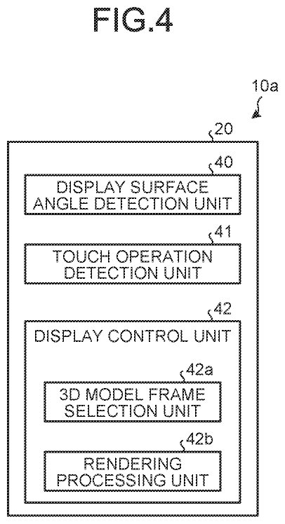

FIG. 4 is a functional block diagram illustrating one example of the functional configuration of the mobile terminal according to the first embodiment. The CPU 20 of the mobile terminal 10a implements a display surface angle detection unit 40, a touch operation detection unit 41, and a display control unit 42 in FIG. 4 as functional units by developing and operating the control program P1 on the RAM 22.

The display surface angle detection unit 40 detects each of the normal directions of the first display area S1 and the second display area S2. In particular, the display surface angle detection unit 40 of the embodiment detects a difference between the normal direction of the first display area S1 and the normal direction of the second display area S2, that is, the angle 91 formed by the first display area S1 and the second display area S2. Furthermore, the display surface angle detection unit 40 detects each of the normal directions of the second display area S2 and the third display area S3. In particular, the display surface angle detection unit 40 of the embodiment detects a difference between the normal direction of the second display area S2 and the normal direction of the third display area S3, that is, the angle θ2 formed by the second display area S2 and the third display area S3. Note that the display surface angle detection unit 40 is one example of a first detection unit in the present disclosure.

The touch operation detection unit 41 detects a touch operation on the first display area S1 (display area), the second display area S2 (display area), and the third display area S3 (display area). Specifically, the touch operation corresponds to various operations described in FIG. 2. Note that the touch operation detection unit 41 is one example of a second detection unit in the present disclosure.

The display control unit 42 changes the display mode of the 3D model 14M (object) by causing an operation performed on the first display area S1 to act on the 3D model 14M from the direction in accordance with the normal direction of the first display area S1. Furthermore, the display control unit 42 changes the display mode of the 3D model 14M by causing an operation performed on the third display area S3 to act on the 3D model 14M from the direction in accordance with the normal direction of the third display area S3. Furthermore, the display control unit 42 changes the display mode of the 3D model 14M by causing an operation performed on the second display area S2 to act on the 3D model 14M. The display control unit 42 further includes a 3D model frame selection unit 42a and a rendering processing unit 42b. Note that the display control unit 42 is one example of a control unit.

The 3D model frame selection unit 42a selects the 3D model 14M in accordance with an operation instruction of the user from a plurality of 3D models M stored in a storage unit 38. For example, when the touch operation detection unit 41 detects an instruction to rotate the 3D model 14M by 90° in the direction of the arrow K1 or K2 in FIG. 2, the 3D model frame selection unit 42a selects a 3D model obtained by rotating the 3D model 14M by 90° from the 3D models M stored in the storage unit 24.

The rendering processing unit 42b draws the 3D model selected by the 3D model frame selection unit 42a in the second display area S2, that is, renders the 3D model.

### 1-4. Flow of Processing Performed by Mobile Terminal

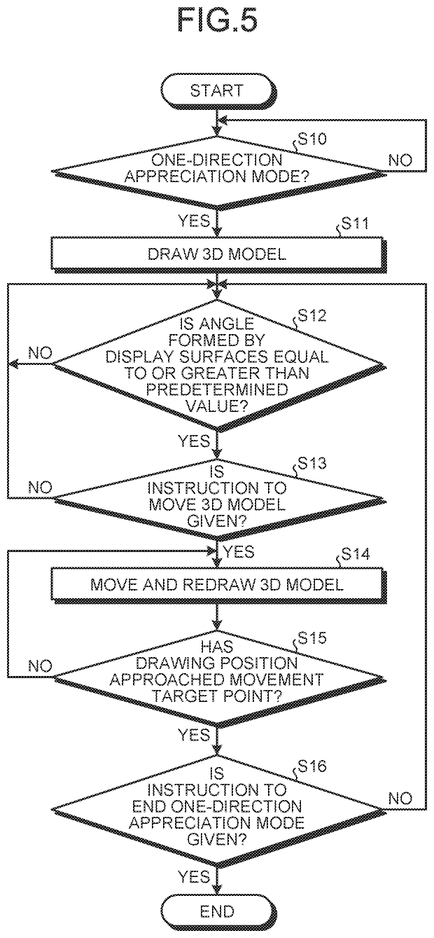

FIG. 5 is a flowchart illustrating one example of the flow of processing performed by the mobile terminal according to the first embodiment. Hereinafter, the flow of processing will be described in order.

The display control unit 42 determines whether the mobile terminal 10a is in a state of executing the one-direction appreciation mode (Step S10). Note that the mobile terminal 10a includes a plurality of display modes, and a display mode to be executed can be selected in a menu screen (not illustrated). When it is determined in Step S10 that the mobile terminal 10a is in the state of executing the one-direction appreciation mode (Step S10: Yes), the processing proceeds to Step S11. In contrast, when it is not determined that the mobile terminal 10a is in the state of executing the one-direction appreciation mode (Step S10: No), Step S10 is repeated.

In the case of determination of Yes in Step S10, the rendering processing unit 42b draws the 3D model 14M selected by the 3D model frame selection unit 42a in the second display area S2 (Step S11).

The display surface angle detection unit 40 determines whether both the angle θ1 and the angle θ2 are equal to or greater than a predetermined value (e.g., 180°) (Step S12). When it is determined that both the angle θ1 and the angle θ2 are equal to or greater than a predetermined value (Step S12: Yes), the processing proceeds to Step S13. In contrast, when it is not determined that both the angle θ1 and the angle θ2 are equal to or greater than a predetermined value (Step 312: No), Step S12 is repeated.

The touch operation detection unit 41 determines whether an instruction to move the 3D model 14M is given (Step S13). When it is determined that the movement instruction is given (Step S13: Yes), the processing proceeds to Step S14. In contrast, when it is not determined that the movement instruction is given (Step S13: No), Step S12 is repeated.

In the case of determination of Yes in Step S13, the rendering processing unit 42b redraws the 3D model 14M selected by the 3D model frame selection unit 42a from the 3D models M in accordance with the movement instruction in the second display area S2 (Step S14).

Subsequently, the rendering processing unit 42b determines whether the drawing position of the 3D model 14M has approached a movement target point in accordance with the operation instruction detected by the touch operation detection unit 41 (Step S15). When it is determined that the drawing position has approached the movement target point in accordance with the operation instruction (Step S15: Yes), the processing proceeds to Step S16. In contrast, when it is not determined that the drawing position has approached the movement target point in accordance with the operation instruction (Step S15: No), the processing returns to Step S14.

In the case of determination of Yes in Step S15, the display control unit 42 determines whether the mobile terminal 10a has been instructed to end the one-direction appreciation mode (Step S16). When it is determined that the mobile terminal 10a has been instructed to end the one-direction appreciation mode (Step S16: Yes), the mobile terminal 10a ends the processing in FIG. 5. In contrast, when it is not determined that the mobile terminal 10a has been instructed to end the one-direction appreciation mode (Step S16: No), the processing returns to Step S12.

### 1-5. Effects of First Embodiment

As described above, according to the mobile terminal 10a of the first embodiment, the display surface angle detection unit 40 (first detection unit) detects a normal direction of the display panel 35 (display unit). The display panel 35 includes display areas (first display area S1, second display area S2, and third display area S3) whose normal directions partially change. Then, the difference between the normal directions of adjacent display areas, that is, the angles θ1 and θ2 formed by the adjacent display areas are detected. Then, when the angles θ1 and θ2 are equal to or greater than predetermined values, the touch operation detection unit 41 (second detection unit) detects a touch operation on each display area. The display control unit 42 (control unit) changes the display mode of the 3D model 14M (object) displayed in the second display area S2 in accordance with a touch operation on each of the display areas (first display area S1, second display area S2, and third display area S3).

This enables the 3D model 14M displayed on the mobile terminal 10a to be freely observed from a designated direction by an intuitive operation.

Furthermore, according to the mobile terminal 10a of the first embodiment, the display areas (first display area S1, second display area S2, and third display area S3) include a foldable display device.

This enables a direction in which an operation is performed on the 3D model 14M to be freely set.

Furthermore, according to the mobile terminal 10a of the first embodiment, the display control unit 42 (control unit) changes the display mode of the 3D model 14M by causing an operation performed on the display areas (first display area S1, second display area S2, and third display area S3) to act on the 3D model 14M (object) from directions corresponding to the normal directions of the display areas (first display area S1, second display area S2, and third display area S3).

This enables the display form of the 3D model 14M to be intuitively and three-dimensionally changed.

### 2. Second Embodiment

A second embodiment of the present disclosure is an example of a mobile terminal (information processing apparatus) having a function of displaying a 3D model in a form in accordance with the orientation of a foldable display area on the display area.

### 2-1. Outline of Mobile Terminal of Second Embodiment

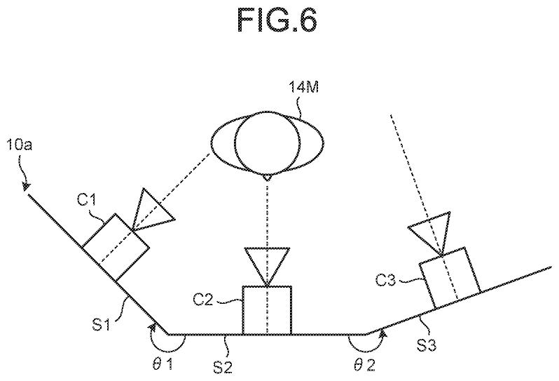

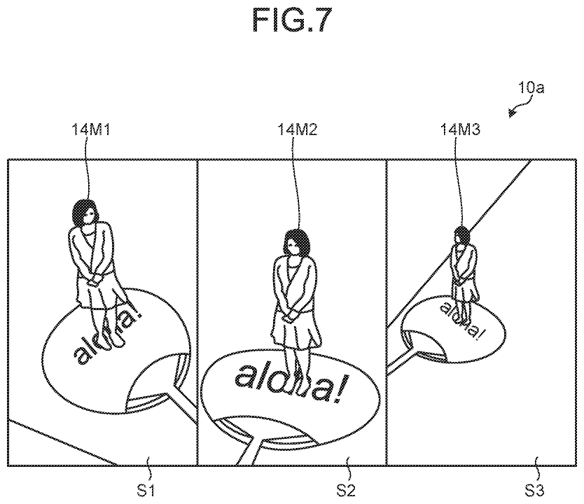

A mobile terminal 10a of the second embodiment will be outlined with reference to FIGS. 6 and 7. FIG. 6 outlines a mobile terminal of the second embodiment. FIG. 7 illustrates one example of a screen displayed on the mobile terminal according to the second embodiment.

FIG. 6 illustrates a 3D model 14M observed (viewed) by using the mobile terminal 10a of the embodiment as viewed from directly above. As described in the first embodiment, the mobile terminal 10a includes three foldable display areas (first display area S1, second display area S2, and third display area S3).

In the case, the mobile terminal 10a displays an image of the 3D model 14M on each of the display areas (S1, S2, and S3). The 3D model 14M is observed from virtual cameras (C1, C2, and C3) facing the normal direction of each display area. That is, an image obtained by observing the 3D model 14M with an angle difference in accordance with an angle θ1 is displayed on the first display area S1 and the second display area S2. Furthermore, an image obtained by observing the 3D model 14M with an angle difference in accordance with an angle θ2 is displayed on the second display area S2 and the third display area S3.

Note that the distance between the mobile terminal 10a and the 3D model 14M and a reference direction need to be preliminarily specified. For example, the mobile terminal 10a displays an image of the 3D model 14M observed from a default distance and direction in the second display area S2 with the second display area S2 as a reference surface. Then, the mobile terminal 10a displays an image obtained by observing the 3D model 14M from the direction in accordance with the angle θ1, which is formed by the first display area S1 and the second display area S2, in the first display area S1. Furthermore, the mobile terminal 10a displays an image obtained by observing the 3D model 14M from the direction in accordance with the angle θ2, which is formed by the second display area S2 and the third display area S3, in the third display area S3.

FIG. 7 illustrates a display example of the 3D model 14M displayed in each of the display areas (S1, S2, and S3) in the case where the mobile terminal 10a is disposed in the state of FIG. 6. That is, a 3D model 14M2 obtained by observing the 3D model 14M from a default distance and direction is displayed in the second display area S2. Then, instead of the 3D model 14M2, a 3D model 14M1 obtained by observing the 3D model 14M from the direction of the angle difference in accordance with the angle θ1 is displayed in the first display area S1. Furthermore, instead of the 3D model 14M2, a 3D model 14M3 obtained by observing the 3D model 14M from the direction of the angle difference in accordance with the angle θ2 is displayed in the third display area S3.

Note that a mode in which the 3D model 14M is simultaneously observed from a plurality of directions as illustrated in FIG. 6 is referred to as a multi-directional simultaneous appreciation mode in the present disclosure for convenience.

Since the mobile terminal 10a of the embodiment has the same hardware configuration and functional configuration as the mobile terminal 10a of the first embodiment, the description of the hardware configuration and the functional configuration will be omitted.

### 2-2. Flow of Processing Performed by Mobile Terminal

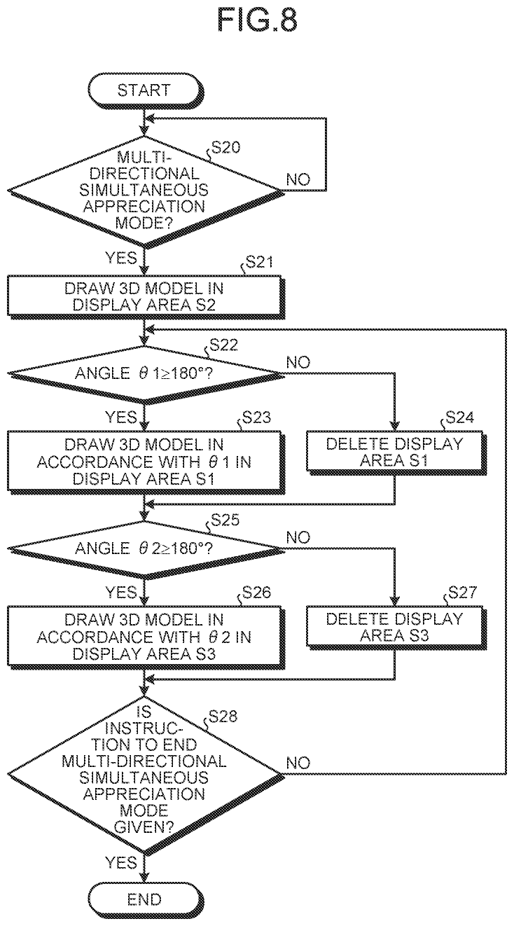

FIG. 8 is a flowchart illustrating one example of the flow of processing performed by the mobile terminal according to the second embodiment. Hereinafter, the flow of processing will be described in order.

A display control unit 42 determines whether the mobile terminal 10a is in a state of executing a multi-directional simultaneous appreciation mode (Step S20). Note that the mobile terminal 10a includes a plurality of display modes, and a display mode to be executed can be selected in a menu screen (not illustrated). When it is determined in Step S20 that the mobile terminal 10a is in the state of executing the multi-directional simultaneous appreciation mode (Step S20: Yes), the processing proceeds to Step S21. In contrast, when it is not determined that the mobile terminal 10a is in the state of executing the multi-directional simultaneous appreciation mode (Step S20: No), Step S20 is repeated.

In the case of determination of Yes in Step S20, a rendering processing unit 42b draws the 3D model 14M2 (see FIG. 7), which is selected by the 3D model frame selection unit 42a and viewed from a default direction, in the second display area S2 (Step S21).

A display surface angle detection unit 40 determines whether the angle θ1 is equal to or greater than 180° (Step S22). When it is determined that the angle θ1 is equal o or greater than 180° (Step S22: Yes), the processing proceeds to Step S23. In contrast, when it is not determined that the angle θ1 is equal o or greater than 180° (Step S22: No), the processing proceeds to Step S24.

In the case of determination of Yes in Step S22, the rendering processing unit 42b draws the 3D model 14M1 (see FIG. 7) in accordance with the angle θ1 in the first display area S1 (Step S23). Thereafter, the processing proceeds to Step S25.

In contrast, in the case of determination of No in Step S22, the rendering processing unit 42b deletes the first display area S1 (Step S24). Thereafter, the processing proceeds to Step S25.

Subsequent to Step S23 or S24, the display surface angle detection unit 40 determines whether the angle θ2 is equal to or greater than 180° (Step S25). When it is determined that the angle θ2 is equal o or greater than 180° (Step S22: Yes), the processing proceeds to Step S26. In contrast, when it is not determined that the angle θ2 is equal o or greater than 180° (Step S25: No), the processing proceeds to Step S27.

In the case of determination of Yes in Step S25, the rendering processing unit 42b draws the 3D model 14M3 (see FIG. 7) in accordance with the angle θ2 in the third display area S3 (Step S26). Thereafter, the processing proceeds to Step S28.

In contrast, in the case of determination of No in Step S25, the rendering processing unit 42b deletes the third display area S3 (Step S27). Thereafter, the processing proceeds to Step S28.

Subsequent to Step S26 or S27, the display control unit 42 determines whether the mobile terminal 10a has been instructed to end the multi-directional simultaneous appreciation mode (Step S28). When it is determined that the mobile terminal 10a has been instructed to end the multi-directional simultaneous appreciation mode (Step S28: Yes), the mobile terminal 10a ends the processing in FIG. 8. In contrast, when it is not determined that the mobile terminal 10a has been instructed to end the multi-directional simultaneous appreciation mode (Step S28: No), the processing returns to Step S22.

### 2-3. Effects of Second Embodiment

As described above, according to the mobile terminal 10a of the second embodiment, the display control unit 42 (control unit) changes the 3D model 14M (object) to be in the mode as viewed from the normal directions of the first display area S1, the second display area S2, and the third display area S3, and draws the 3D model 14M in each of the display areas (S1, S2, and S3).

This enables the 3D model 14M to be easily observed from a plurality of free directions.

### 3. Third Embodiment

A third embodiment of the present disclosure is an example of a mobile terminal (information processing apparatus) having a function of observing a 3D model from four directions. In the third embodiment, a mobile terminal including foldable four display areas is disposed in a quadrangular prism. The 3D model virtually exists inside the quadrangular prism.

### 3-1. Outline of Mobile Terminal of Third Embodiment

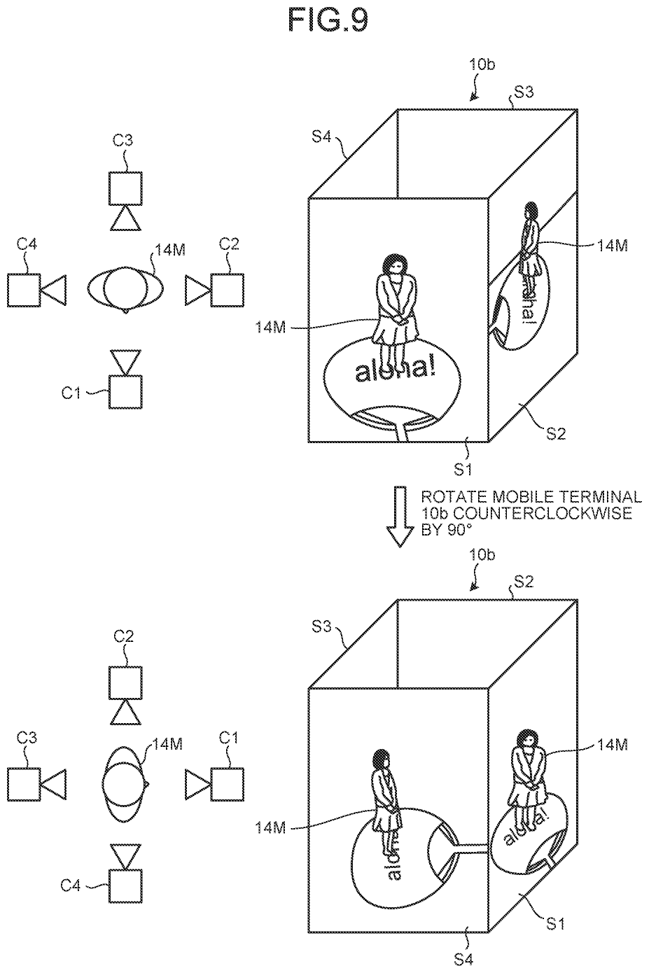

A mobile terminal 10b of the third embodiment will be outlined with reference to FIG. 9. FIG. 9 outlines a mobile terminal of the third embodiment.

A display panel 35 (display unit) (see FIG. 3) of the mobile terminal 10b includes four continuous display areas (first display area S1, second display area S2, third display area S3, and fourth display area S4). Each of the display areas (S1, S2, S3, and S4) can freely turn with a turning axis provided between adjacent display areas as a supporting axis (see FIG. 1).

In the embodiment, the mobile terminal 10b is disposed with the display areas (S1, S2, S3, and S4) constituting a quadrangular prism (columnar body). Then, the mobile terminal 10b draws an image obtained by observing a 3D model 14M from the normal direction of each display area in each display area assuming that the 3D model 14M virtually exists inside the quadrangular prism. In such a way, an image obtained by observing the 3D model 14M from four directions is displayed in each display area.

That is, as illustrated in FIG. 9, an image obtained by observing the 3D model 14M with a virtual camera C1 is displayed in the first display area S1. The virtual camera C1 faces the normal direction of the first display area S1. Similarly, an image obtained by observing the 3D model 14M with a virtual camera C2 is displayed in the second display area S2. The virtual camera C2 faces the normal direction of the second display area S2. Furthermore, an image obtained by observing the 3D model 14M with a virtual camera C3 is displayed in the third display area S3. The virtual camera C3 faces the normal direction of the third display area S3. Then, an image obtained by observing the 3D model 14M with a virtual camera C4 is displayed in the fourth display area S4. The virtual camera C4 faces the normal direction of the fourth display area S4.

Here, the quadrangular prism formed by the display areas of the mobile terminal 10b is rotated counterclockwise by 90° while keeping the shape of the quadrangular prism. In the case, the mobile terminal 10b rotates together with the 3D model 14M. Therefore, the same image is displayed in each of the display areas (S1, S2, S3, and S4) regardless of the rotation angle of the quadrangular prism.

As described above, the mobile terminal 10b enables a lot of people to simultaneously observe the 3D model 14M from a plurality of directions by displaying the 3D model 14M in the quadrangular prism formed by the display areas (S1, S2, S3, and S4) in a mode in accordance with the normal directions of the display areas. Furthermore, the 3D model 14M can be observed from a free direction by rotating the quadrangular prism. Note that a mode in which a lot of people simultaneously observe the 3D model 14M from a plurality of directions as in the embodiment is referred to as a multi-person appreciation mode in the present disclosure for convenience.

Note that, although the mobile terminal 10b has been described as having four display areas, the number of display areas is not limited to four. That is, as long as the columnar body is formed by folding the display panel 35 (display unit), the same function effects as described above can be obtained. That is, three display areas at minimum are required to be provided. In the case, since a triangular prism is formed by folding the display panel 35, the mobile terminal 10b can display images obtained by observing the 3D model 14M from three different directions. Note that even the mobile terminal 10b having equal to or greater than five display areas can obtain similar function effects.

The hardware configuration of the mobile terminal 10b is obtained by adding, for example, a gyro sensor 36 (not illustrated) as a sensor that detects the rotation angle of the quadrangular prism shaped mobile terminal 10b to the hardware configuration of the mobile terminal 10a described in the first embodiment. Furthermore, the functional configuration of the mobile terminal 10b is obtained by adding a rotation angle detection unit 46 (not illustrated) that detects the rotation angle of the quadrangular prism shaped mobile terminal 10b to the hardware configuration of the mobile terminal 10a described in the first embodiment.

### 3-2. Flow of Processing Performed by Mobile Terminal

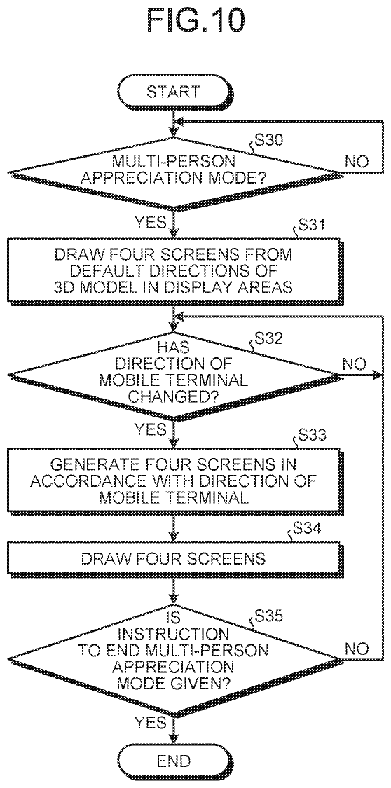

FIG. 10 is a flowchart illustrating one example of the flow of processing performed by the mobile terminal according to the third embodiment. Hereinafter, the flow of processing will be described in order.

The display control unit 42 determines whether the mobile terminal 10b is in a state of executing the multi-person appreciation mode (Step S30). Note that the mobile terminal 10b includes a plurality of display modes, and a display mode to be executed can be selected in a menu screen (not illustrated). When it is determined in Step S30 that the mobile terminal 10b is in the state of executing the multi-person appreciation mode (Step S30: Yes), the processing proceeds to Step S31. In contrast, when it is not determined that the mobile terminal 10b is in the state of executing the multi-person appreciation mode (Step S30: No), Step S30 is repeated.

The rendering processing unit 42b draws an image obtained by observing the 3D model 14M from a preset default direction in each of the display areas (S1, S2, S3, and S4) of the mobile terminal 10b (Step S31). The preset default direction is determined by, for example, an arrangement such as drawing an image of the 3D model 14M viewed from the front in the first display area S1. When the observation direction of the first display area S1 is determined, the observation directions of the other display areas (S2, S3, and S4) are uniquely determined.

Next, the rotation angle detection unit 46 (not illustrated) determines whether the direction of the mobile terminal 10b forming the quadrangular prism has changed, that is, whether the mobile terminal 10b has rotated (Step S32). When it is determined that the direction of the mobile terminal 10b has changed (Step S32: Yes), the processing proceeds to Step S33. In contrast, when it is not determined that the direction of the mobile terminal 10b has changed (Step S32: No), the determination in Step S32 is repeated.

In the case of determination of Yes in Step S32, the 3D model frame selection unit 42a generates an image to be drawn in each of the display areas (S1, S2, S3, and S4) in accordance with the direction of the mobile terminal 10b (Step S33). Specifically, the 3D model frame selection unit 42a selects a 3D model in accordance with the direction of each display area from 3D models M stored in the storage unit 24.

Then, the rendering processing unit 42b draws each image generated in Step S33 in each of corresponding display areas (S1, S2, S3, and S4) (Step S34).

Next, the display control unit 42 determines whether the mobile terminal 10b has been instructed to end the multi-person appreciation mode (Step S35). When it is determined that the mobile terminal 10b has been instructed to end the multi-person appreciation mode (Step S35: Yes), the mobile terminal 10b ends the processing in FIG. 10. In contrast, when it is not determined that the mobile terminal 10b has been instructed to end the multi-person appreciation mode (Step S35: No), the processing returns to Step S32.

### 3-3. Effects of Third Embodiment

As described above, according to the mobile terminal 10b (information processing apparatus) of the third embodiment, the display panel 35 (display unit) includes at least three or more display areas (first display area S1, second display area S2, third display area S3, and fourth display area S4). When the display panel 35 is disposed in a columnar body, the display control unit 42 (control unit) changes the display mode of the 3D model 14M (object), which is displayed in each display area and virtually exists inside the columnar body, to be in a mode as viewed from the normal direction of each display area.

This enables the 3D model 14M to be simultaneously observed (viewed) by a lot of people from a plurality of directions.

Furthermore, according to the mobile terminal 10b of the third embodiment, when a columnar body formed by display areas of the mobile terminal 10b is rotated around the 3D model 14M (object), the display control unit 42 (control unit) rotates the 3D model 14M together with the display areas (first display area S1, second display area S2, third display area S3, and fourth display area S4).

This enables a user to observe (view) the 3D model 14M from a free direction by changing the direction of the mobile terminal 10b forming the columnar body.

### 3-4. Variation of Third Embodiment

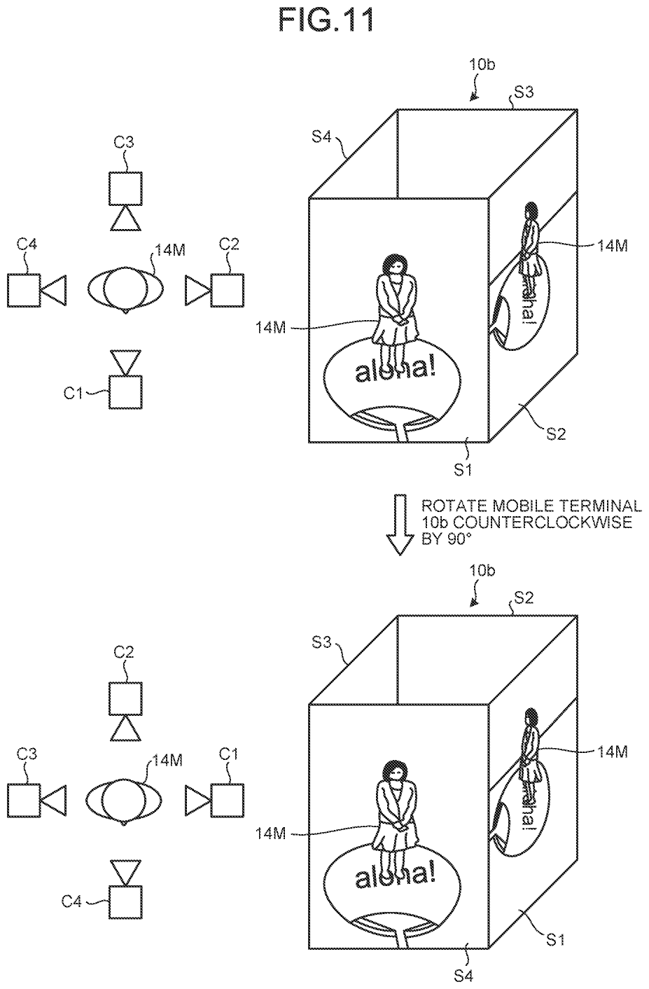

FIG. 11 outlines a variation of the third embodiment. The variation of the third embodiment is an example of a mobile terminal (information processing apparatus) having a function of observing a 3D model from four directions. In the third embodiment, a mobile terminal including foldable four display areas is disposed in a quadrangular prism. The 3D model exists inside the quadrangular prism. In particular, when the mobile terminal 10b disposed in a quadrangular prism is rotated while keeping the shape of the quadrangular prism, a mobile terminal of the variation of the third embodiment does not rotate the 3D model 14M virtually existing inside a columnar body together with the mobile terminal 10b.

That is, as illustrated in FIG. 11, images obtained by observing the 3D model 14M with the virtual cameras C1 to C4 are displayed in the first display area S1 to the fourth display area S4.

In the state, the quadrangular prism formed by the display areas of the mobile terminal 10b is rotated counterclockwise by 90° while keeping the shape of the quadrangular prism. In the case, the mobile terminal 10b rotates without the 3D model 14M. Therefore, in the case of observing (viewing) an image from the same direction, the same image is always observed even when the display areas (S1, S2, S3, and S4) are changed.

For example, in the example of FIG. 11, an image of the 3D model 14M viewed from the front is drawn in the first display area S1 before the mobile terminal 10b is rotated. Then, when the mobile terminal 10b is rotated counterclockwise by 90°, the fourth display area S4 comes to the position where the first display area S1 has been provided. Then, an image of the 3D model 14M viewed from the front is drawn in the fourth display area S4. As described above, the same image can be always observed (viewed) from the same direction. That is, the mobile terminal 10b can be regarded as exhibiting a case where the 3D model 14M is covered.

### 3-5. Effects of Variation of Third Embodiment

As described above, according to the mobile terminal 10b (information processing apparatus) of the third embodiment, when a columnar body formed by display areas of the mobile terminal 10b is rotated around the 3D model 14M (object), the display control unit 42 (control unit) does not rotate the 3D model 14M together with the display areas (first display area S1, second display area S2, third display area S3, and fourth display area S4).

This enables the same image to be always observed (viewed) from the same direction regardless of the installation direction of the mobile terminal 10b.

### 4. Fourth Embodiment

A fourth embodiment of the present disclosure is an example of a mobile terminal (information processing apparatus) having a function of detecting a folding operation of a display unit and a display area that a user (observer and operator) faces and moving a 3D model displayed in the display area to an appropriate position where the user can easily observe (view) the 3D model.

### 4-1. Outline of Mobile Terminal of Fourth Embodiment

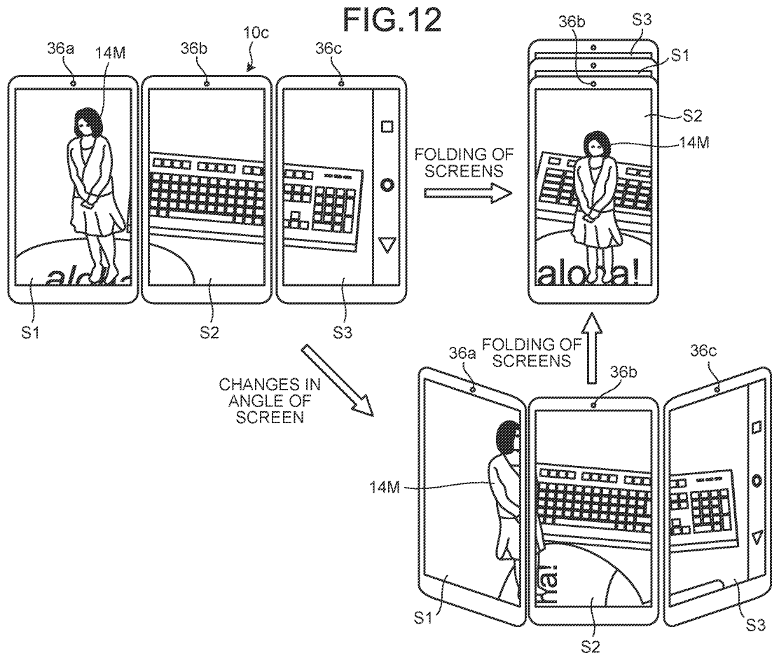

A mobile terminal 10c of the fourth embodiment will be outlined with reference to FIG. 12. FIG. 12 outlines a mobile terminal according to the fourth embodiment.

As in each of the above-described embodiments, the mobile terminal 10c includes a plurality of foldable display areas (three display areas (S1, S2, and S3) in example of FIG. 12). A 3D model 14M is displayed in any of the display areas. Furthermore, cameras 36a, 36b, and 36c that capture an image in the direction of each display area are installed near each display area. These cameras (36a, 36b, and 36c) image the face of a user operating the mobile terminal 10c. The image captured by each of the cameras (36a, 36b, and 36c) is processed inside the mobile terminal 10c to determine which of the display areas (S1, S2, and S3) the face of the user faces. Then, the mobile terminal 10c moves the display position of the 3D model 14M to the display area which is determined to be faced by the user. This causes the mobile terminal 10c to display the 3D model 14M in a display area where the 3D model 14M is easily observed (viewed) regardless of the folded state of the display areas (S1, S2, and S3).

Specific operations of the mobile terminal 10c will be described with reference to FIG. 12. In an initial state, the 3D model 14M is displayed in the first display area S1 with each of the display area (S1, S2, and S3) opened. When the display areas are completely folded in this state, as illustrated in the upper right of FIG. 12, the second display area S2 moves to the front side, and the other display areas are hidden behind the second display area S2. Although FIG. 12 illustrates the display areas at positions shifted for illustration, the first display area S1 and the third display area S3 are actually hidden behind the second display area S2. Then, the mobile terminal 10c determines that the user faces the second display area S2, and draws the 3D model 14M in the second display area S2.

The operation of folding the display areas of the mobile terminal 10c goes through the state in which angles of the display areas are changed as illustrated in the lower right of FIG. 12, and transitions to the state in which the display areas are completely folded as illustrated in the upper right of FIG. 12. Furthermore, when the user holds the mobile terminal 10c in the initial state with his/her hand and observes (views) the 3D model 14M, an angle of each display area changes as illustrated in the lower right of FIG. 12, for example, in the middle of movement.

As described above, the mobile terminal 10c detects a display area faced by the user, and moves the 3D model 14M to the display area determined to be faced by the user at the time when the mobile terminal 10c is in the state of the lower right of FIG. 12.

In the example in the lower right of FIG. 12, the mobile terminal 10c determines that the user faces the second display area S2, and moves the 3D model 14M drawn in the first display area S1 to the second display area S2. The figure in the lower right of FIG. 12 illustrates the 3D model 14M in the middle of movement. Note that the 3D model 14M drawn in the first display area S1 may be deleted and moved to the second display area S2 without passing through such a state in the middle of movement.

Note that, in addition to determining a display area faced by the user by using images captured by the cameras 36a, 36b, and 36c, the display area gripped by the user may be detected to avoid drawing the 3D model 14M in the display area. Whether the user grips a display area can be determined by analyzing output of a touch panel 33 (see FIG. 3) of each display area.

In the present disclosure, a mode of moving the 3D model 14M to an appropriate position where the 3D model 14M is easily observed (viewed) as illustrated in FIG. 12 is referred to as a 3D model movement display mode for convenience.

Note that the hardware configuration of the mobile terminal 10c of the embodiment is obtained by adding the cameras 36a, 36b, and 36c for each of the display areas to the hardware configuration of the mobile terminal 10a of the first embodiment.

### 4-2. Functional Configuration of Mobile Terminal

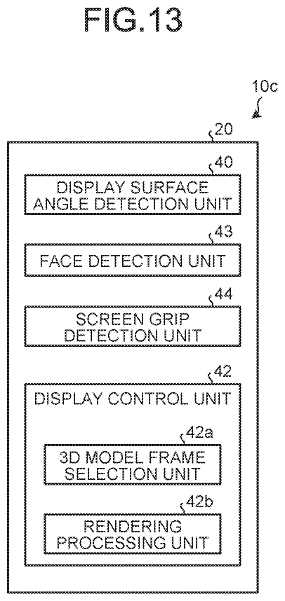

FIG. 13 is a functional block diagram illustrating one example of the functional configuration of the mobile terminal according to the fourth embodiment. The mobile terminal 10c includes a face detection unit 43 and a screen grip detection unit 44 in comparison to the functional configuration of the mobile terminal 10a (see FIG. 4). Note that the touch operation detection unit 41 of the mobile terminal 10a may be substituted for the screen grip detection unit 44.

The face detection unit 43 determines which display area the user faces based on images of the user face captured by the cameras 36a, 36b, and 36c.

The screen grip detection unit 44 detects that the user grips a display area. When a display area is gripped, the contact area of a finger generally increases, so that the screen grip detection unit 44 determines that the display area is gripped in the case where the size of the contact area exceeds a predetermined value. Then, when determining that a display area is gripped, the screen grip detection unit 44 determines that the user does not face the display area. Note that, since the display area gripped in the folded state is hidden in the display area on the front side, a camera of the hidden display area does not recognize the user face. Therefore, usually, as long as at least the face detection unit 43 is provided, a state in which the user faces a display area can be detected. Then, the mobile terminal 10c can improve the detection accuracy of a display area faced by the user by using the detection result of the screen grip detection unit 44 in combination.

### 4-3. Flow of Processing Performed by Mobile Terminal

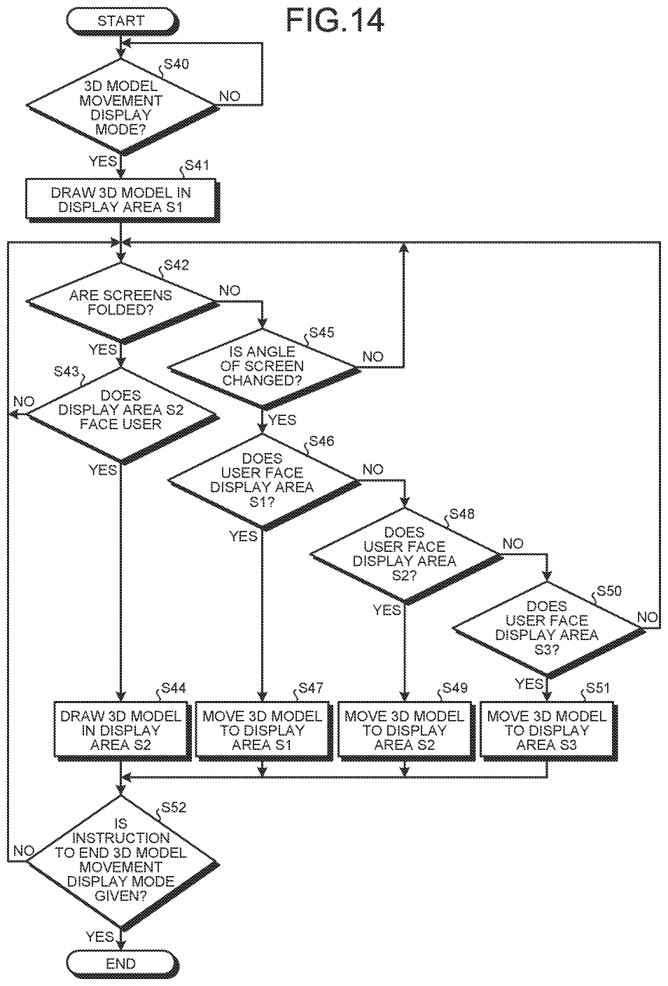

FIG. 14 is a flowchart illustrating one example of the flow of processing performed by the mobile terminal according to the fourth embodiment. Hereinafter, the flow of processing will be described in order. Note that, for simplicity, description will be given assuming that a display area faced by a user is detected by using only a detection result of the face detection unit 43 without using the screen grip detection unit 44.

The display control unit 42 determines whether the mobile terminal 10c is in a state of executing the 3D model movement display mode (Step S40). Note that the mobile terminal 10c includes a plurality of display modes, and a display mode to be executed can be selected in a menu screen (not illustrated). When it is determined in Step S40 that the mobile terminal 10c is in the state of executing the 3D model movement display mode (Step S40: Yes), the processing proceeds to Step S41. In contrast, when it is not determined that the mobile terminal 10c is in the state of executing the 3D model movement display mode (Step S40: No), Step S40 is repeated.

In the case of determination of Yes in Step S40, the rendering processing unit 42b draws the 3D model 14M in the first display area S1, which is a default display area (Step S41).

The display surface angle detection unit 40 determines whether the display unit is folded (Step S42). When it is determined that the display unit is folded (Step S42: Yes), the processing proceeds to Step S43. In contrast, when it is not determined that the display unit is folded (Step S42: No), the processing proceeds to Step S45.

In the case of determination of Yes in Step S42, the face detection unit 43 determines whether the second display area S2 faces the user (Step S43). When it is determined that the second display area S2 faces the user (Step S43: Yes), the processing proceeds to Step S44. In contrast, when it is not determined that the second display area S2 faces the user (Step S43: No), the processing proceeds to Step S42.

In contrast, in the case of determination of No in Step S42, the display surface angle detection unit 40 determines whether the angle of each display area is changed (Step S45). When it is determined that the angle of each display area is changed (Step S45: Yes), the processing proceeds to Step S46. In contrast, when it is not determined that the angle of each display area is changed (Step S45: No), the processing proceeds to Step S42.

In the case of determination of Yes in Step S45, the face detection unit 43 determines whether the first display area S1 faces the user (Step S46). When it is determined that the first display area S1 faces the user (Step S46: Yes), the processing proceeds to Step S47. In contrast, when it is not determined that the first display area S1 faces the user (Step S46: No), the processing proceeds to Step S48.

In the case of determination of No in Step S46, the face detection unit 43 determines whether the second display area S2 faces the user (Step S48). When it is determined that the second display area S2 faces the user (Step S48: Yes), the processing proceeds to Step S49. In contrast, when it is not determined that the second display area S2 faces the user (Step S48: No), the processing proceeds to Step S50.

In the case of determination of No in Step S48, the face detection unit 43 determines whether the third display area S3 faces the user (Step S50). When it is determined that the third display area S3 faces the user (Step S50: Yes), the processing proceeds to Step S51. In contrast, when it is not determined that the third display area S3 faces the user (Step S50: No), the processing proceeds to Step S42.

Returning to Step S43, in the case of determination of Yes in Step S43, the rendering processing unit 42b moves the 3D model 14M to the second display area S2, and performs drawing (Step S44). Thereafter, the processing proceeds to Step S52.

Returning to Step S46, in the case of determination of Yes in Step S46, the rendering processing unit 42b moves the 3D model 14M to the first display area S1, and performs drawing (Step S47). Thereafter, the processing proceeds to Step S52.

Returning to Step S48, in the case of determination of Yes in Step S48, the rendering processing unit 42b moves the 3D model 14M to the second display area S2, and performs drawing (Step S49). Thereafter, the processing proceeds to Step S52.

Returning to Step S50, in the case of determination of Yes in Step S50, the rendering processing unit 42b moves the 3D model 14M to the third display area S3, and performs drawing (Step S51). Thereafter, the processing proceeds to Step 352.

Subsequent to Steps S44, S47, S49, and 351, the display control unit 42 determines whether the mobile terminal 10c has been instructed to end the 3D model movement display mode (Step S52). When it is determined that the mobile terminal 10c has been instructed to end the 3D model movement display mode (Step S52: Yes), the mobile terminal 10c ends the processing in FIG. 14. In contrast, when it is not determined that the mobile terminal 10c has been instructed to end the 3D model movement display mode (Step S52: No), the processing returns to Step S42.

### 4-4. Effects of Fourth Embodiment

As described above, according to the mobile terminal 10c (information processing apparatus) of the fourth embodiment, the display control unit 42 (control unit) moves the 3D model 14M (object) in accordance with the change of the normal direction of the display unit.

This causes the 3D model 14M to move in accordance with the folded state of the display areas (S1, S2, and S3), so that natural interaction can be achieved.

Furthermore, according to the mobile terminal 10c (information processing apparatus) of the fourth embodiment, the display control unit 42 (control unit) moves the 3D model 14M (object) based on a state in which the user faces the display areas (S1, S2, and S3).

This enables the 3D model 14M to be displayed on a display area which the user focuses on, so that interaction in accordance with intention of the user can be achieved.

Note that each of the above-described embodiments may have the functions of a plurality of different embodiments. Then, in the case, the mobile terminal includes all the hardware configurations and functional configurations of the plurality of embodiments.

### 5. Fifth Embodiment

A fifth embodiment of the present disclosure is an example of an information processing apparatus having a function of changing the display mode of an object in accordance with deflection of a display panel.

### 5-1. Outline of Information Processing Apparatus of Fifth Embodiment

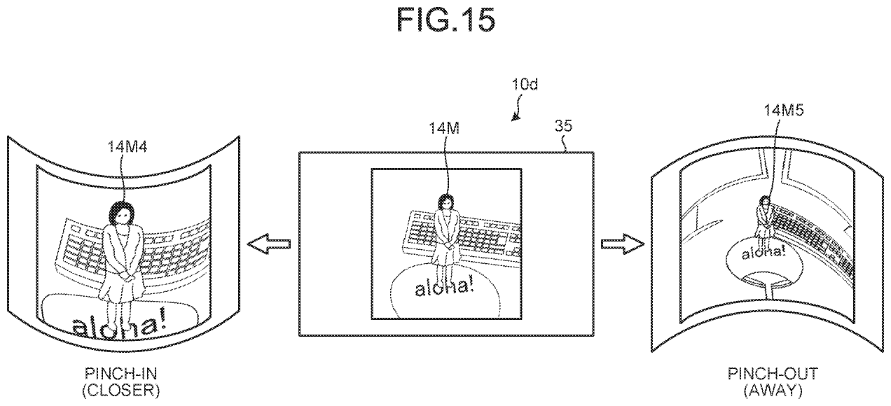

FIG. 15 illustrates one example of an information processing apparatus according to the fifth embodiment. An information processing apparatus 15d includes a thin-film flexible display panel 35 (display unit). The display panel 35 includes, for example, an organic light emitting diode (OLED). Since the display panel using the OLED can be formed thinner than a liquid crystal panel, the display panel can be deflected to some extent.

As illustrated in FIG. 15, a 3D model 14M can be displayed on the display panel 35. Then, when the display panel 35 is deflected, the display mode of the 3D model 14M is changed in accordance with the deflection direction.

That is, when the display panel 35 is deflected such that the front side (observer side) protrudes, the information processing apparatus 15d displays a 3D model 14M4 on the display panel 35. That is, the object is enlarged and displayed. This is the same as the display obtained at the time when a pinch-in operation is performed with the 3D model 14M being displayed.

In contrast, when the display panel 35 is deflected such that the front side (observer side) is recessed, the information processing apparatus 15d displays a 3D model 14M5 on the display panel 35. That is, the object is reduced and displayed. This is the same as the display obtained at the time when a pinch-out operation is performed with the 3D model 14M being displayed.

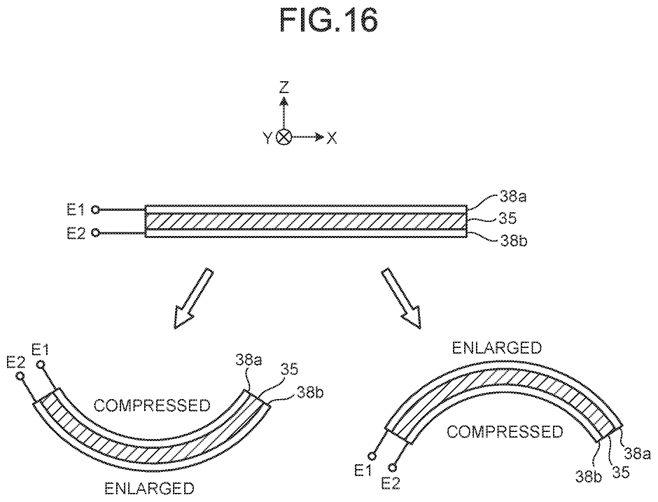

FIG. 16 illustrates a method of detecting deflection of the display panel. A transparent piezoelectric film 38a is laminated on the front side (Z-axis positive side) of the display panel 35. Furthermore, a transparent piezoelectric film 38b is laminated on the back side (Z-axis negative side) of the display panel 35. The piezoelectric film 38a and the piezoelectric film 38b output a voltage in accordance with pressure applied to the piezoelectric films. Note that the piezoelectric film 38a and the piezoelectric film 38b have equal characteristics. Note that the piezoelectric film 38a laminated on the surface of the display panel 35 can also be used as a touch panel used at the time when the display panel 35 is operated.

The piezoelectric film 38a outputs a voltage in accordance with the state of deflection of the piezoelectric film 38a itself to an end terminal E1. Furthermore, the piezoelectric film 38a outputs a voltage in accordance with the state of deflection of the piezoelectric film 38a itself to an end terminal E2.

In FIG. 16, a scene in which a user observes (views) the front side of the display panel 35 from the Z-axis positive side is assumed. In the case, when the user deflects the display panel 35 such that the front side is recessed, the piezoelectric film 38a is compressed as illustrated in FIG. 16. In contrast, the piezoelectric film 38b is enlarged. The information processing apparatus 15d detects that the display panel 35 is deflected such that the user side is recessed by performing arithmetic processing on a voltage output from the end terminal E1 at the time and a voltage output from the end terminal E2. Note that the specific content of the arithmetic processing is determined in accordance with the specifications of the piezoelectric films 38a and 38b to be used. Then, when detecting that the user side is deflected to be a recessed surface, the information processing apparatus 15d changes the 3D model 14M to the 3D model 14M5 (see FIG. 15).

In contrast, when the user deflects the display panel 35 such that the front side protrudes, the piezoelectric film 38a is enlarged as illustrated in FIG. 16. In contrast, the piezoelectric film 38b is compressed. The information processing apparatus 15d detects that the display panel 35 is deflected such that the user side protrudes by performing arithmetic processing on a voltage output from the end terminal E1 at the time and a voltage output from the end terminal E2. Note that the specific content of the arithmetic processing is determined in accordance with the specifications of the piezoelectric films 38a and 38b to be used. Then, when detecting that the user side is deflected to be a protruding surface, the information processing apparatus 15d changes the 3D model 14M to the 3D model 14M4 (see FIG. 15).

As described above, the information processing apparatus 15d can change the display mode of the displayed object by an intuitive operation of the user.

### 5-2. Hardware Configuration of Information Processing Apparatus

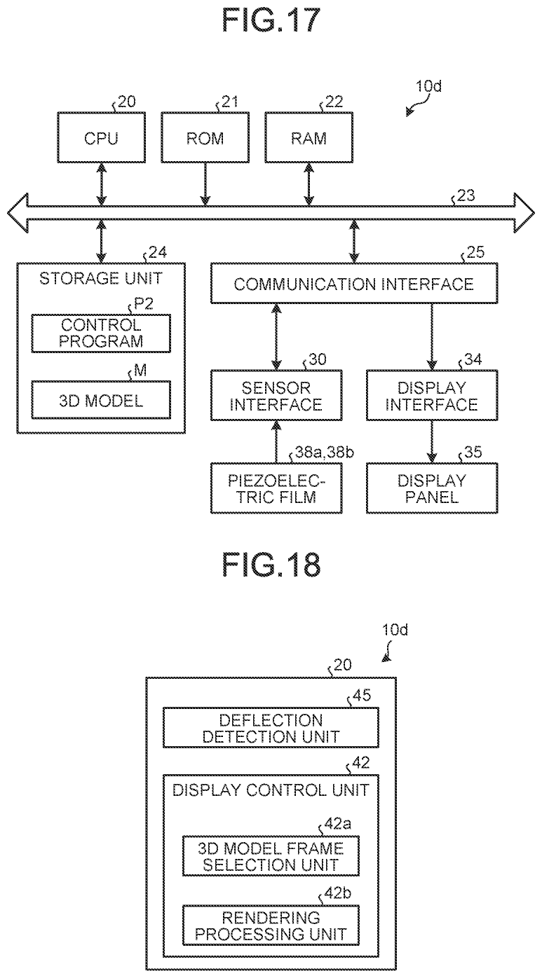

FIG. 17 is a hardware block diagram illustrating one example of the hardware configuration of the information processing apparatus according to the fifth embodiment.

An information processing apparatus 10d has a hardware configuration substantially equal to that of the mobile terminal 10a (see FIG. 3). The hardware configuration of the mobile terminal 10a is different in the following three points. That is, the information processing apparatus 10d includes a control program P2 for implementing a function specific to the information processing apparatus 10d. Furthermore, the information processing apparatus 10d connects the piezoelectric films 38a and 38b via the sensor interface 30. Moreover, since the piezoelectric film 38a can have the function of a touch panel in the information processing apparatus 10d, the sensor interface 30 also has the function of the touch panel interface 32.

### 5-3. Functional Configuration of Information Processing Apparatus

FIG. 18 is a functional block diagram illustrating one example of the functional configuration of the information processing apparatus according to the fifth embodiment. The CPU 20 of the information processing apparatus 10d implements a deflection detection unit 45 in FIG. 18 and the display control unit 42 as functional units by developing and operating the control program P2 on the RAM 22. Note that, although omitted in FIG. 18, the information processing apparatus 10d may include the touch operation detection unit 41 (see FIG. 4) as necessary.

The deflection detection unit 45 detects a state of deflection of the display panel 35. Note that the deflection detection unit 45 is one example of the first detection unit in the present disclosure. The function of the display control unit 42 is the same as the function of the display control unit 42 of the mobile terminal 10a.

Since the contents of specific processing performed by the information processing apparatus 10d are as described in FIGS. 15 and 16, the repeated description will be omitted.

### 5-4. Effects of Fifth Embodiment

As described above, according to the information processing apparatus 10d of the fifth embodiment, the display panel 35 (display unit) includes a flexible display device.

This enables the display mode of an object to be changed by an intuitive operation of deflecting the display panel 35.

Furthermore, according to the information processing apparatus 10d of the fifth embodiment, the display control unit 42 (control unit) changes the display scale of the 3D model 14M (object) in accordance with the state (normal direction) of deflection of the display panel 35 (display unit).

This enables the scaling (display mode) of the object to be changed by an intuitive operation.

Furthermore, according to the information processing apparatus 10d of the fifth embodiment, the display control unit 42 (control unit) expands and displays the 3D model 14M (object) when the display area has a protruding surface toward the user (observer), and reduces and displays the 3D model 14M (object) when the display area has a recessed surface toward the user (observer).

This causes the 3D model 14M to be expanded when the display panel 35 approaches the user (becomes protruding surface toward user), and causes the 3D model 14M to be reduced when the display panel 35 moves away from the user (becomes recessed surface toward user). Therefore, the display mode of the object can be changed to match the feeling of the user.

Note that the effects set forth in the specification are merely examples and not limitations. Other effects may be exhibited. Furthermore, the embodiments of the present disclosure are not limited to the above-described embodiments, and various modifications can be made without departing from the gist of the present disclosure.

Note that the present disclosure may also have the configurations as follows.

(1)

An information processing apparatus comprising:

a first detection unit that detects a normal direction of a display unit including a display area whose normal direction partially or continuously changes;

a second detection unit that detects a touch operation on the display area; and

a control unit that changes a display mode of an object displayed on the display area in accordance with at least one of the normal direction and a touch operation on the display area.

(2)

The information processing apparatus according to (1), wherein the display unit includes a display device including a foldable display area.

(3)

The information processing apparatus according to (1) or (2),

wherein the control unit changes a display mode of the object by causing an operation performed on the display area to act on the object from a direction in accordance with a normal direction of the display area.

(4)

The information processing apparatus according to (1) or (2),

wherein the control unit changes the object to be in a mode as viewed from a normal direction of the display unit.

(5)

The information processing apparatus according to (1),

wherein the display unit includes at least three or more display areas, and

when the display areas are disposed in a columnar body, the control unit changes a display mode of the object, which is displayed on the display areas and virtually exists inside the columnar body, to a mode in a case where the object is viewed from a normal direction of each of the display areas.

(6)

The information processing apparatus according to (5), wherein, when the columnar body is rotated around the object, the control unit rotates the object together with the display area.

(7)

The information processing apparatus according to (5), wherein, when the columnar body is rotated around the object, the control unit does not rotate the object together with the display area.

(8)

The information processing apparatus according to (1) or (2),

wherein the control unit moves the object in accordance with change in a normal direction of the display unit.

(9)

The information processing apparatus according to (8), wherein the control unit moves the object based on a state in which a user faces the display area.

(10)

The information processing apparatus according to (1), wherein the display unit includes a flexible display device.

(11)

The information processing apparatus according to (10),

wherein the control unit changes a display scale of the object in accordance with a normal direction of the display unit.

(12)

The information processing apparatus according to (10),

wherein the control unit expands and displays the object when the display area has a protruding surface toward an observer, and

reduces and displays the object when the display area has a recessed surface in a direction opposite to the observer.

(13)

An information processing method comprising:

a first detection process of detecting a normal direction of a display unit including a display area whose normal direction partially or continuously changes;

a second detection process of detecting a touch operation on the display area; and

a control process of changing a display mode of an object displayed on the display area in accordance with at least one of the normal direction and a touch operation on the display area.

(14)

A program causing a computer to function as:

a first detection unit that detects a normal direction of a display unit including a display area whose normal direction partially or continuously changes;

a second detection unit that detects a touch operation on the display area; and

a control unit that changes a display mode of an object displayed on the display area in accordance with at least one of the normal direction and a touch operation on the display area.

### REFERENCE SIGNS LIST

10a, 10b, 10c MOBILE TERMINAL (INFORMATION PROCESSING APPARATUS)
10d INFORMATION PROCESSING APPARATUS
14M 3D MODEL (OBJECT)
35 DISPLAY PANEL (DISPLAY UNIT)
40 DISPLAY SURFACE ANGLE DETECTION UNIT (FIRST DETECTION UNIT)
41 TOUCH OPERATION DETECTION UNIT (SECOND DETECTION UNIT)
42 DISPLAY CONTROL UNIT (CONTROL UNIT)
45 DEFLECTION DETECTION UNIT (FIRST DETECTION UNIT)
46 ROTATION ANGLE DETECTION UNIT
A1, A2 TURNING AXIS
S1 FIRST DISPLAY AREA (DISPLAY AREA)
S2 SECOND DISPLAY AREA (DISPLAY AREA)
S3 THIRD DISPLAY AREA (DISPLAY AREA)
S4 FOURTH DISPLAY AREA (DISPLAY AREA)
C1, C2, C3, C4 VIRTUAL CAMERA

1. An information processing apparatus comprising:
a first detection unit that detects a normal direction of a display unit including a display area whose normal direction partially or continuously changes;
a second detection unit that detects a touch operation on the display area; and
a control unit that changes a display mode of an object displayed on the display area in accordance with at least one of the normal direction and a touch operation on the display area.

2. The information processing apparatus according to claim 1,
wherein the display unit includes a display device including a foldable display area.

3. The information processing apparatus according to claim 2,
wherein the control unit changes a display mode of the object by causing an operation performed on the display area to act on the object from a direction in accordance with a normal direction of the display area.

4. The information processing apparatus according to claim 2,
wherein the control unit changes the object to be in a mode as viewed from a normal direction of the display unit.

5. The information processing apparatus according to claim 1,
wherein the display unit includes at least three or more display areas, and
when the display areas are disposed in a columnar body, the control unit changes a display mode of the object, which is displayed on the display areas and virtually exists inside the columnar body, to a mode in a case where the object is viewed from a normal direction of each of the display areas.

6. The information processing apparatus according to claim 5,
wherein, when the columnar body is rotated around the object, the control unit rotates the object together with the display area.

7. The information processing apparatus according to claim 5,
wherein, when the columnar body is rotated around the object, the control unit does not rotate the object together with the display area.

8. The information processing apparatus according to claim 2,
wherein the control unit moves the object in accordance with change in a normal direction of the display unit.

9. The information processing apparatus according to claim 8,
wherein the control unit moves the object based on a state in which a user faces the display area.

10. The information processing apparatus according to claim 1,
wherein the display unit includes a flexible display device.

11. The information processing apparatus according to claim 10,
wherein the control unit changes a display scale of the object in accordance with a normal direction of the display unit.

12. The information processing apparatus according to claim 10,
wherein the control unit expands and displays the object when the display area has a protruding surface toward an observer, and
reduces and displays the object when the display area has a recessed surface toward the observer.

13. An information processing method comprising:
a first detection process of detecting a normal direction of a display unit including a display area whose normal direction partially or continuously changes;
a second detection process of detecting a touch operation on the display area; and
a control process of changing a display mode of an object displayed on the display area in accordance with at least one of the normal direction and a touch operation on the display area.

14. A program causing a computer to function as:
a first detection unit that detects a normal direction of a display unit including a display area whose normal direction partially or continuously changes;
a second detection unit that detects a touch operation on the display area; and
a control unit that changes a display mode of an object displayed on the display area in accordance with at least one of the normal direction and a touch operation on the display area.
